(19) United States
(12) Patent Application Publication
(10) Pub. No.: US 2023/0251491 A1
(43) Pub. Date: Aug. 10, 2023

(54) Viewing Equipment

(71) Applicant: Zappar Limited, Auchterarder (GB)

(72) Inventors: Simon John Taylor, (US); Steven Richard Spong, (US)

(21) Appl. No.: 18/245,744

(22) PCT Filed: Sep. 9, 2021
(86) PCT No.: PCT/GB2021/052340

§ 371 Date: Mar. 17, 2023

(30) Foreign Application Priority Data
Sep. 18, 2020 (GB) 2014762.5

(51) Int. Cl. G02B 27/01

(52) U.S. Cl. CPC G02B 27/0172; G02B 27/0176; G02B 7/14

(57) ABSTRACT

A headset for use as part of an Augmented Reality apparatus comprises a headband arranged to secure the headset to a user's head; and a mount connected to the headband and arranged to detachably receive a display device in a position arranged to be in front of a user's eyes in use. The headset is arranged, insofar as possible, not to block a user's peripheral vision. The mount may comprise a pair of arms arranged to support the display device. The headset may comprise a pair of lenses connected to the headband and arranged to be located between the user's eyes and the display device, wherein the lenses are double convex lenses with a flat lower edge, the flat lower edge of each lens being arranged to fall on a plane extending between a user's expected pupil location and a lower edge of the mount. The mount may be transparent.

The invention relates to viewing equipment, and the use thereof. The viewing equipment may be of particular utility in Augmented Reality (AR) or Virtual Reality (VR) systems. In particular, but not exclusively, the viewing equipment may comprise a viewing device such as a headset arranged to be worn by a user and to have a display device mounted thereon. In particular, but not exclusively, the viewing equipment may comprise one or more optical lenses arranged to adjust a user's view. The one or more lenses may be mounted on a headset or other support to which a display device is also arranged to be connected.

As used herein, the term “headset” refers to an apparatus arranged to be worn/mounted on a user's head so as to hold one or more devices or other elements in place for a specific use, such as viewing AR content (which may also be referred to as mixed-reality, MR, content). The term “headset” therefore does not necessarily imply the presence of a microphone or speaker (e.g. a headphone/earphone or loudspeaker), although such devices may be present in, or mounted on, the headset in some embodiments.

As used herein, the term “display device” means any device having a display capable of showing visual data to a user, such as a smartphone, tablet, television screen, video screen, or the like.

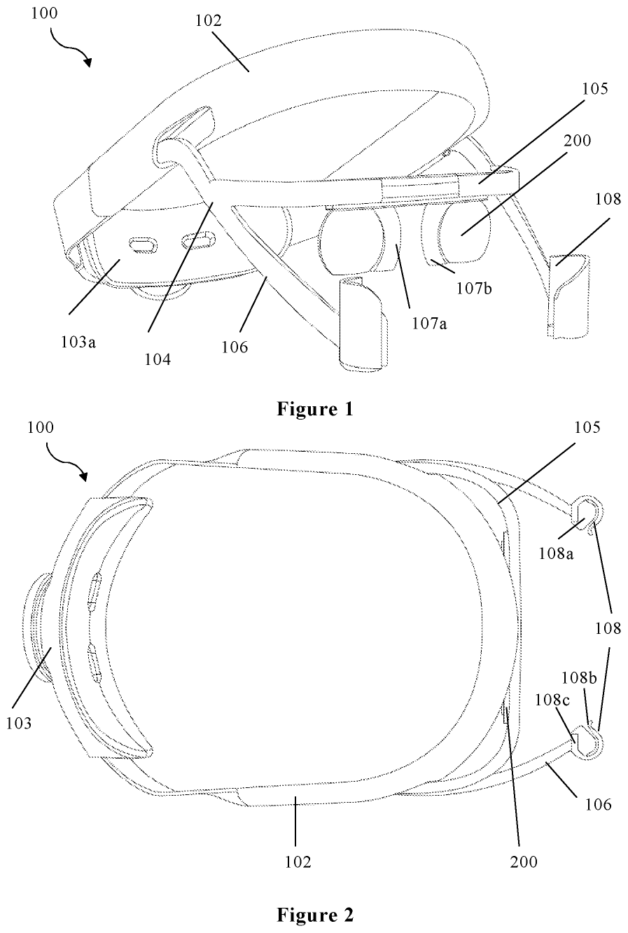

As used herein, words such as “forward”, “upper”, “lower”, “higher”, “downward”, “vertical”, “horizontal”, and the like are used with respect to a standard position of the headset if a user wearing the headset is sitting or standing straight, looking straight ahead (forward), as is shown in FIG. 1. It will be appreciated that the headset can be used at different angles with respect to a user, and/or by users positioned at different angles, and that these descriptors are not intended to be limiting, but rather used for ease of reference only.

According to a first aspect of the invention, there is provided a headset for use as part of an Augmented Reality (or Virtual Reality) apparatus, the headset comprising:
a headband arranged to secure the headset to a user's head; and
a mount connected to the headband and arranged to detachably receive a display device in a position arranged to be in front of a user's eyes in use;
   and wherein the headset is arranged not to block a user's peripheral vision.

It will be appreciated that some small part(s) of a user's peripheral vision may be covered by the headset as described herein, but that any such covering is reduced or minimised as compared to prior art headsets such that a user still has some/a reasonable amount of peripheral vision—the user's peripheral vision as a whole is therefore not blocked. The headset may be thought of as an example of a viewing device—it is a device arranged to be used to assist a user in viewing AR or VR content.

Wearable viewing devices for use in VR scenarios to date deliberately enclose a user's eyes to shield the user from view of the actual, unmodified, surroundings. By contrast, the headset of the present disclosure is arranged (insofar as possible) not to block a user's peripheral vision.

The mount may be at least substantially transparent. Advantageously, this may reduce the visibility of the mount, therefore assisting in minimising or avoiding any blockage of a user's peripheral vision. The transparency may facilitate blending content displayed on the display device (e.g. digital content) with a user's peripheral vision (around the edges of the device).

The mount may be arranged to receive a display device which is or comprises a smartphone, or other device suitable for video see-through mixed reality applications. The device may be opaque.

The mount may comprise a pair of arms, the arms being arranged to support the device. Each arm may be arranged to hold and support one side of the device. The headset may otherwise be open around the device—the arms may be the only part of the headset to make contact with the device. One arm may extend on either side of the user's face in use, with the device held therebetween. The mount may comprise only two arms.

One arm may be arranged to lie on or near either side of the display device in use, each arm comprising a holder arranged to support or engagingly receive one end/side of the display device (left and right sides, respectively). Each holder may comprise a lower surface, or base, arranged to hold a lower edge of a display device received thereby at or around a set vertical level with respect to the headset (irrespective of device height).

The mount therefore may not have the form of a box or goggles as seen in the prior art, but rather may comprise an open arrangement of struts/arms.

The mount may therefore comprise a pair of arms, each arm being connected to a respective side of the headband (and therefore on a respective side of a user's head/face in use) and extending forward and downward from the headband, and each arm comprising a holder arranged to support the display device.

The mount may therefore comprise a pair of arms, one arranged to lie on or near either side of the display device in use, and each arm comprising a holder arranged to engagingly receive one end of the display device.

The arms may be resiliently biased towards each other, such that display devices of varying widths may be gripped, accommodated, and held in a central position (even when the holder of each arm holds an outer edge of the device). The biased, or sprung, arms may therefore provide a holder for a display device (e.g. a smartphone or video screen), with a simple, inbuilt, centring mechanism arranged to urge the display device into its intended, central, position.

The cross-section of each arm may increase in thickness from upper side to lower side, for example having a substantially trapezoidal or triangular cross-section. Beneficially, this variation in arm thickness, especially in a region of the arm adjoining a holder for a display device, may tailor arm flexibility so as to improve display device positioning.

In other embodiments, the arms may be more rigidly-positioned relative to each other (i.e. they may not be live-hinged); in such embodiments, a holder design may be selected which allows a display device to extend beyond the holder, so as to facilitate use with a range of device sizes. It will be appreciated that each holder is still near a respective side/edge of the display device in such embodiments, and so can be referred to as holding that side/end of the display device.

In the various embodiments, the arms are arranged to hold a lower edge of the display device in a predetermined position relative to the lenses.

The headband may be arranged, in use, to encircle a user's head at an angle to the horizontal, such that the headband passes above a user's eyes, and around the back of a user's head at a level lower than the user's eyes. In various embodiments, the angle of the headband may not be fixed or maintained in any active way by the headset, but the headset may be designed such that, when the headband is at a set angle (e.g. of around 26° to the horizontal), a screen of a display device mounted thereon, and optionally one or more lenses mounted thereon, may be vertical when a user is looking straight ahead. Putting on the headset whilst maintaining the mount at such an angle as to allow the screen of the display device to be vertical may therefore automatically result in the headband lying at the set angle. Experimentation with a variety of users to find an optimal angle that would give a solid yet comfortable fit indicated that arranging the headband with the back below the “head bump”—the region on the rear of the skull around the upper region of the occipital bone which generally extends the furthest backwards—and the front of the headband higher up on the forehead where the skull begins to curve backwards may advantageously prevent the weight of the display device from pulling the headset forwards and downwards whilst also providing a comfortable fit.

In various embodiments, the headset comprises a mount for mounting a video see-through display device in front of a user's eyes in use, such that the user can view a screen of the display device directly, and a pair of lenses in front of a user's eyes and between the user's eyes and the display device in use (or at least connectors for a pair of lenses arranged to locate the lenses in that position once connected).

In embodiments with a mount comprising a pair of arms, the arms may follow a straight trajectory from the angled headband to a location arranged to receive a lower edge of the display device, and may be arranged such that a screen of the display device is at least substantially vertical in use.

The arms may therefore be arranged to follow a straight trajectory from the headband to the base of a display device (e.g. a smartphone), and the headband may be arranged to be angled in use, such that it sits higher at the front of a user's head than at the back. The straight trajectory may be at an angle of greater than 90° to the headband, and arranged to extend forward and downward away from the headband. This arrangement may beneficially reduce stress on components, and/or allow for a lightweight product framework.

The mount may be arranged to be slideable along the headband. Advantageously, this may provide easy to use adaptability to different head shapes/profiles.

The headset may further comprise one or more connectors. The one or more connectors may be arranged to hold lenses between the user's eyes and the display device. The one or more connectors may be arranged to allow the lenses to be moved closer together or further apart, so allowing adjustment for a user's specific inter-pupillary distance. The connectors may be connected to/mounted on the headband, optionally via the mount which is also arranged to support the display device.

The one or more connectors, where present, may be arranged to have the lenses removably connected thereto, such that lenses can be replaced.

Two connectors may be provided; the connectors may be slidable relative to each other so as to allow a distance between lenses to be adjusted.

Advantageously, the ability to remove and replace lenses, and/or to move connectors so as to change lens spacing may allow the apparatus to be adapted to users with different prescriptions, and/or with different inter-pupillary distances (IPDs). The interchangeability and adaptability of the lenses may therefore allow the same apparatus to be used by a wider range of users, and more comfortably.

The one or more connectors may be arranged such that there is no part of the connector forming a frame around a lower edge of a lens received thereon, and such that there is no requirement for the lens to have a frame or any other formation to be received by the connector on the lower edge thereof. The lower edge of the lens may therefore be frameless/unframed.

The headset may further comprise a pair of lenses mounted thereon, optionally by connectors as described above. The lenses may be mounted on the mount. The connectors may be connected to, or may be a part of, the mount (i.e. they may be integral with the mount in some embodiments). The mount and lenses together may be seen as a glasses-type structure, and all components of the glasses-type structure may be transparent, so beneficially reducing visibility of any frame/surround and assisting in blending the digital display with a user's peripheral vision. The mount may be arranged to hold a display device such that the display device, and in particular a lower edge of the display device, is in a predetermined position relative to the lenses.

The lenses may be double convex lenses, and may be arranged to reduce a user's view of one or more edges of a display device mounted on the headset, and/or to maximise a user's view below the display device. The lenses may therefore assist in maximising the amount of a user's peripheral vision (in particular to the sides of, and below, the display device) which is not blocked. The lenses may therefore assist in restricting a user's view to a digital display of the display device and the user's peripheral vision whilst providing minimal interruption therebetween. In the embodiments shown in the figures, the user's vision above the display device is also not impeded—the top is open. In alternative or additional embodiments, one or more covers (optionally removable) may be provided on the headset to block light entering from above the display device—for example, this may reduce unwanted reflections in some environments. The sides/edges of a user's vision and the user's vision beneath the display device remain unimpeded in such embodiments.

A lower edge of each lens may be flat. The flat edge may be arranged to form a line falling on a plane extending between a user's expected pupil location and a lower edge/surface of the mount—i.e. the lower edge of each lens may align with/be in that plane. In use, the flat edge may therefore lie in a plane extending between a user's expected pupil location and a lower edge of a display of the display device. The lower edge/surface of the mount may be the edge or surface of the mount which is arranged to support a lower edge of the display device.

The or each lens may therefore be effectively “cut-away” to form a bottom edge based at least approximately on the plane from an expected pupil location to the bottom of the holder for the display device. Advantageously, this arrangement may facilitate maintaining peripheral vision as much as possible without the display device being visible outside of the lens. The shaping adjustment on the bottom edge of the lens, as compared to traditional lens designs which are generally curved on their lower edges, may assist in blending real and virtual images as seamlessly as possible.

The or each lens may be made from a material which has a refractive index of around 1.5 for a wavelength of 589 nm; optionally the material may be poly(methyl methacrylate).

The or each lens may be made from a polymeric material. The polymeric material may be transparent, and optionally may be colourless.

The headset may be provided with a set of detachable covers. The covers may be arranged to be detachably connected to the headset so as to block some or all of a user's peripheral vision when desired. The headset may therefore be convertible between an open headset providing peripheral vision (e.g. for AR or Mixed Reality scenarios) and a more enclosed headset offering less or no peripheral vision (e.g. for full VR scenarios).

According to another aspect, there may therefore be provided a kit of parts for a convertible AR/VR headset for use as part of an Augmented Reality or Virtual Reality apparatus, the headset comprising:
a headband arranged to secure the headset to a user's head; and
a mount connected to the headband and arranged to detachably receive a display device in a position arranged to be in front of a user's eyes in use; and wherein the headset is arranged not to block a user's peripheral vision,
   and wherein the kit of parts further comprises one or more covers arranged to be detachably connected to the headset so as to block all or part of a user's peripheral vision.

The headset may be as described in the first aspect.

The headset may comprise one or more attachment means, e.g. clips, indentations, or protrusions, arranged to allow or facilitate detachable connection of a cover thereto. The attachment means may be provided on the mount, and optionally on arms of the mount.

According to a second aspect, there is provided a headset for use as part of an Augmented Reality (or Virtual Reality) apparatus, the headset comprising:
a headband arranged to secure the headset to a user's head;
a mount connected to the headband and arranged to detachably receive a display device in front of a user's eyes; and
a pair of lenses connected to the headband and arranged to be located between the user's eyes and the display device in use,
   and wherein the lenses are double convex lenses with a flat lower edge, the flat lower edge of each lens being arranged to fall on a plane extending between a user's expected pupil location and a lower edge of the mount.

The lower edge of the mount may align with, and support, a lower edge of the display device in use. The flat lower edge of each lens may therefore equivalently be described as being arranged to fall on a plane extending between a user's expected pupil location and an expected position of a lower edge of the display device.

Advantageously, this lens shape may remove or disguise a user's view of an edge of a display device, such as a phone edge (often comprising a bezel and/or controls), thereby restricting visible elements to a digital display of the display device (or a portion thereof) and the user's peripheral vision without interruption/with only minimal interruption. This may improve immersiveness in Augmented Reality applications, in which it may be desirable to seamlessly blend a view of digital content with a view of a user's surroundings, and may also improve safety by providing an improved awareness of the surroundings.

The lower edge of each lens may be frameless.

The headset of the first embodiment may have some or all of the features of the second embodiment, and vice versa.

According to a third aspect of the invention, there is provided a headset for use as part of an Augmented Reality (or Virtual Reality) apparatus, the headset comprising:
a headband arranged to secure the headset to a user's head; and
a transparent mount connected to the headband and arranged to detachably receive a display device in a position arranged to be in front of a user's eyes in use.

The mount may additionally be arranged to have a pair of lenses connected thereto, and/or may have a pair of lenses integral therewith, the lenses being arranged to lie between a user's eyes and the display device in use. The lenses may be as described above.

The headset of the third embodiment may have some or all of the features of the first and/or second embodiments, and vice versa.

According to a fourth aspect, there is provided use of a headset as claimed in any preceding claim for augmented reality applications.

According to a fifth aspect, there is provided a viewing device for use as part of an Augmented Reality or Virtual Reality apparatus, the viewing device comprising:
a support;
two lenses, each lens being a double convex lens with a flat lower edge and being connected to the support; and
a display device holder, the display device holder being connected to the support and arranged to engagingly receive a display device such that a lower edge of the display device is held in a predetermined position relative to the lenses.

The viewing apparatus is arranged such that the display device, and in particular a screen of the display device (or a portion thereof), can be viewed through the lenses in use.

30 The display device holder may be arranged to hold the display device in front of a user's eyes in use, such that a screen of the display device (or a portion thereof) can be viewed by the user through the lenses.

The flat lower edge of each lens may be arranged to lie on a plane extending between a user's expected pupil location and the predetermined position of the lower edge of the display device.

The display device holder may have a lower surface arranged to support a lower edge of a display device in use. The flat lower edge of each lens may be arranged to lie on a plane extending between a user's expected pupil location and the lower surface of the display device holder.

The expected pupil location of the user may be the expected pupil location when a user is looking straight ahead—this may be an intermediate or average position between a user looking up, down, left, or right.

The support may be arranged to hold/support the lenses and the display device holder in a set relative position. In some embodiments, the support may additionally support the display device—in other embodiments, the display device may support the viewing device, for example with the viewing device clipped to the display device, and a user holding the display device, and thereby holding the viewing device in place. In such embodiments, the display device holder may or may not grip the display device sufficiently that the display device would not come loose were the combined apparatus instead held by the support by a user.

The display device holder may be integral with the support.

The support may be, at least in part, made of a transparent material. The lenses may be integral with the support.

The support may comprise a headset, the headset being arranged to hold the lenses in a set position in front of a user's eyes in use. The headset may be as described with respect to the first aspect.

Alternatively, the support may be arranged to be manually positioned and held by a user in use.

The support may be arranged to clip to the display device, and to be held in place in use by a user holding the display device.

Embodiments of the invention may therefore provide a stripped back mixed reality headset, or other viewing device, that seamlessly blends digital video content with a user's real world peripheral vision. In the embodiments being described, the implementation is “video see through” mixed reality, where virtual images are superimposed on a live camera/video feed. The skilled person would appreciate that, in some embodiments, a headset or other viewing device as described herein could be used for “optical see through” mixed reality, in which the display device is substantially transparent, at least in part, and provides a virtual overlay that the user can see superimposed on the “real” optical image. The differences in how the images are combined may not require any substantial modifications to the headset described herein, although different lenses, or no lenses, may be used for optical see-through embodiments.

The “video see-through” approach to AR uses a camera providing the view of the real world and both real and virtual content are shown on the screen—mixing the two is therefore a digital process. By contrast, “optical see-through” approaches usually involve a half-silvered mirror that reflects a display for virtual content but allows some light from the real world to pass through too, so the mixing of real and virtual happens optically, not digitally.

The skilled person would understand that features described with respect to one aspect of the invention may be applied, mutatis mutandis, to any other aspect of the invention.

There now follows by way of example only a detailed description of embodiments of the present invention with reference to the accompanying drawings in which:

FIG. 1 shows a perspective view of a headset of an embodiment;

FIG. 2 shows a plan view of the headset of FIG. 1;

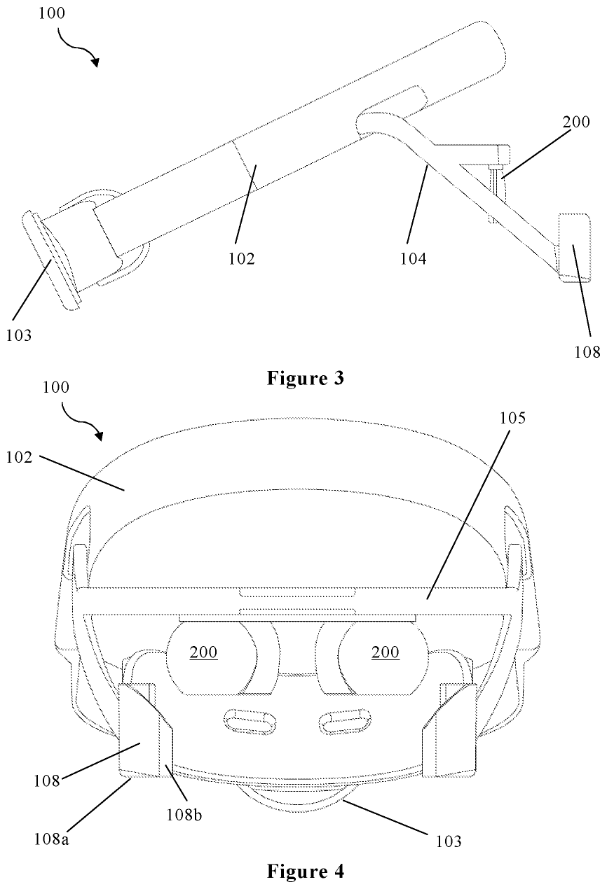

FIG. 3 shows a side view of the headset of FIG. 1;

FIG. 4 shows a front view of the headset of FIG. 1;

FIG. 5 shows the headset side view of FIG. 3 with various dimensions marked;

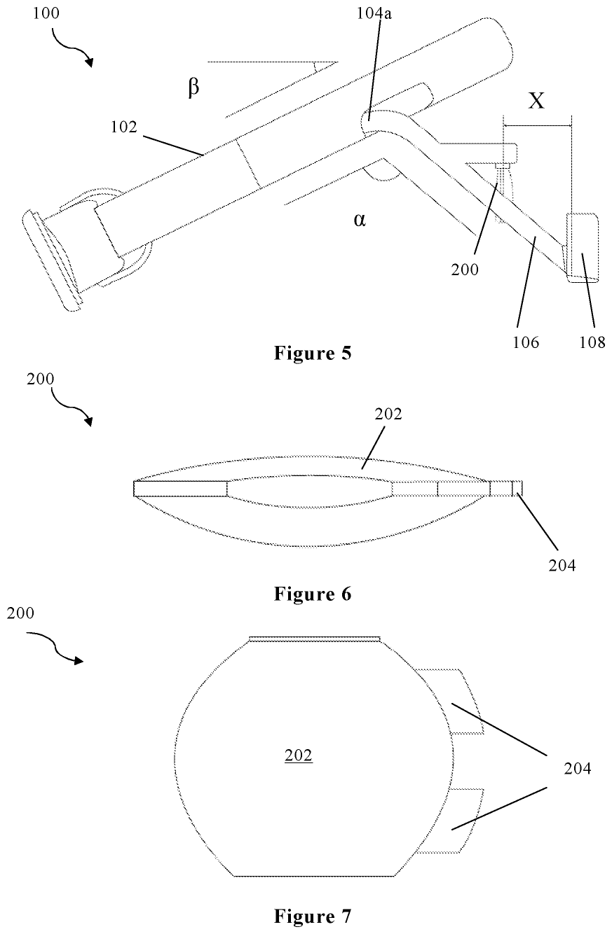

FIG. 6 shows a plan view of a lens, the lens optionally being that shown in FIG. 1;

FIG. 7 shows a front view of the lens of FIG. 6;

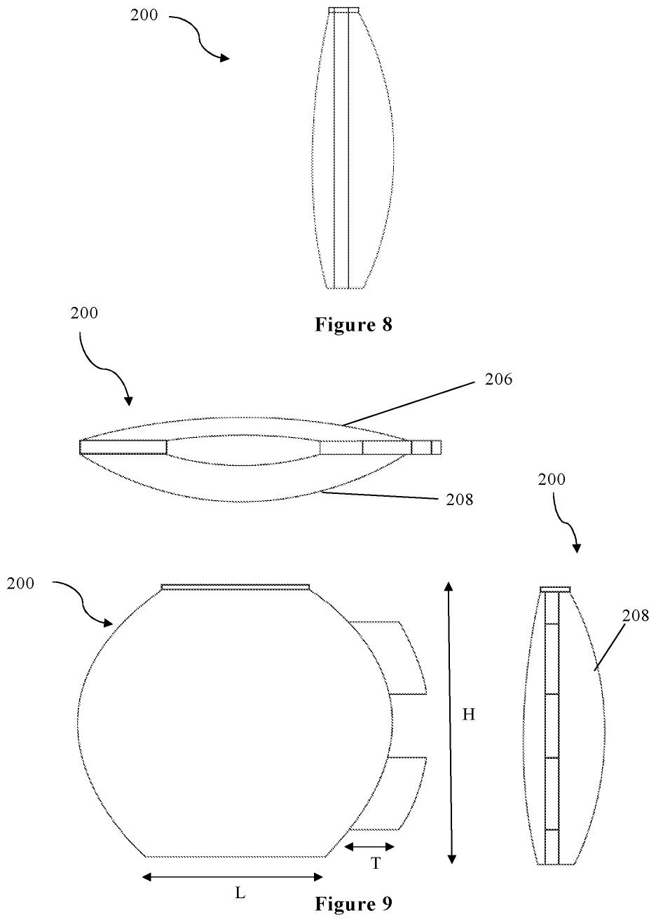

FIG. 8 shows a side view of the lens of FIG. 6;

FIG. 9 shows the lens views of FIGS. 6 to 8 with various dimensions marked; and

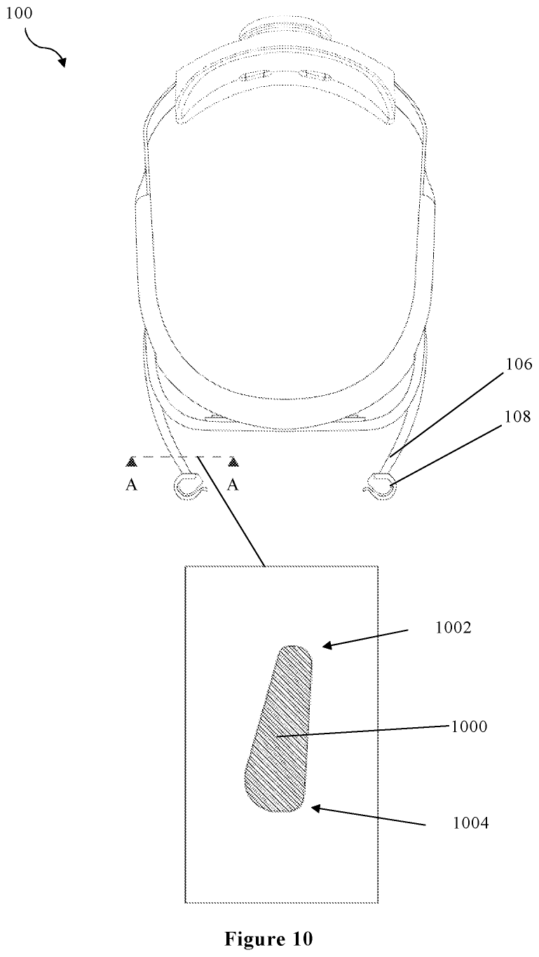

FIG. 10 shows a plan view of the headset of FIG. 1 alongside a cross-sectional view of a marked arm portion.

In the figures, like or corresponding reference numerals are used for like or corresponding features.

FIG. 1 illustrates a viewing device 100, and in particular a headset 100, of an embodiment. The headset 100 is arranged to be worn on a user's head, and comprises a headband 102 arranged to secure the headset 100 to the user's head in use. The headband 102 may also be referred to as a strap. The headband 102 is arranged to have other components of the headset 100 connected thereto, and to support those components. The headband 102 is arranged to allow the user's head/skull to support the weight of the headset 100 and any device(s) mounted thereon.

In the embodiment shown, the headband 102 is arranged to fully encircle a user's head. In alternative embodiments, other designs may be used; for example, a band 102 around a rear part of a user's head only may be connected to a band at an angle thereto arranged to go on top of a user's head and behind the ears, not passing around the forehead, or the headband 102 may form an incomplete loop with a gap at the back, with the ends of the band resiliently biased towards each other to grip a user's head.

In the embodiment shown, the headband 102 comprises an adjustor 103 arranged to allow the headband 102 to be loosened or tightened to fit different head sizes. The adjustor 103 of the embodiment shown also comprises a support 103a, which is padded and shaped for comfort and, in this embodiment, arranged to sit behind and in contact with a user's head in use. The support 103a is wider than the headband strap and may help to distribute weight more comfortably. In the embodiment shown, the headband 102 is made of a semi-rigid, flexible polymeric material, being sufficiently rigid to hold its shape and support the weight of a display device whilst retaining sufficient flexibility for ease of fitting. In alternative embodiments, a material of at least part of the headband 102 may be elasticated or otherwise inherently adjustable such that no separate adjustor 103 may be needed to fit a range of head sizes.

An “off-the-shelf” traditional headband design may be used to provide the headband 102 of the headset 100 described herein.

The headband 102 as described herein may allow the weight to be borne directly by a user's head/skull, with little or no weight on the user's nose or ears. The skilled person would appreciate that many different headband 102 designs are possible whilst still providing a better weight distribution than would be provided by a glasses-type mounting arrangement, in which a substantial amount of weight may be supported by a user's nose and/or ears, and that the embodiment shown is described in detail by way of non-limiting example only.

For example, in alternative embodiments, the headband 102 may form a part of a hat or other headgear into which the headset 100 is incorporated.

In the embodiment shown, the headband 102 is arranged, in use, to encircle a user's head at an angle, β, to the horizontal, such that the headband passes above a user's eyes and around the back of a user's head at a level lower than the user's eyes.

The headset 100 further comprises a mount 104. The mount 104 is arranged to be connected to the headband 102 and supported thereby. In some embodiments, the mount 104 may be integral with the headband 102; in other embodiments, such as the embodiment shown, the mount 104 is a separate component mounted on the headband 102.

The mount 104 is arranged to receive a display device in a position arranged to be in front of a user's eyes in use, such that a user can view a display of the display device held by the mount 104 when wearing the headset 100. The mount 104 is arranged to hold a display device in a predetermined position with respect to the headband 102, and therefore with respect to a user's head in use.

In some embodiments, the display device may be a self-contained device such as a smartphone. In other embodiments, the display device may be a component of a larger device; for example a screen connected to a separate processor and/or power source. It will be appreciated that, in many embodiments, self-contained devices may be preferred to avoid any restriction on a user's movement due to cables or the like. In other embodiments, a separate screen may be preferred, for example to reduce display device weight.

The display device may be a smartphone and the display of the display device may be a smartphone screen.

Unlike prior art headsets which deliberately enclose a user's eyes and the display device, the headset 100 of the embodiments being described is arranged not to block a user's peripheral vision. Interference with a user's field of view is minimised by the headset design, whilst still allowing a display device to be held in front of a user's face. Various factors may be used to accomplish this, including one or more of the below:
headset shape, in particular shape of the mount 104;
headset material choices, in particular materials for the mount 104; and
lens design (described below).

In the embodiment being described, the headset mount 104 is made of an at least substantially transparent material, so as not to block a user's field of view—the user may be able to at least partially see through the mount 104. For example, in the embodiment being described a transparent polymeric material (and more specifically transparent polypropylene) is used for all components of the mount 104. The mount 104 is therefore at least substantially transparent.

In the embodiment being described, the headset mount 104 comprises a framework of relatively narrow arms and/or struts 105, 106, so as to reduce or minimise the area around a user's eyes occupied by a headset component. Each strut 105, 106 may have a width (parallel to the surface of a user's head) of no more than 2 cm, optionally of no more than 1.5 cm, and further optionally of no more than 1 cm. Each strut 105, 106 may have a thickness (perpendicular to the surface of a user's head) of no more than 1 cm, optionally of no more than 0.5 cm, and further optionally of no more than 0.3 cm. The use of relatively thin struts 105, 106, preferably made of a lightweight but sufficiently rigid polymeric material, may reduce or avoid possible obstruction to a user's peripheral vision.

In some embodiments, a top cover may be provided (optionally arranged to detachably clip to the mount 104) so as to block light entering from above. This may reduce glare in some scenarios, whilst not impeding a user's peripheral vision to the sides of and below the display device. In some embodiments, detachable covers may be provided for the sides and underneath of the display device—these covers may clip to the mount 104, and may impede or fully block peripheral vision. The headset 100 may therefore be used in a “fully enclosed” mode, more akin to prior art VR headsets—the headset and removable covers approach described herein allows a single device 100 to offer both maximum peripheral view and fully immersive VR experiences, with perhaps options in between (e.g. top cover only). The headset 100, and more specifically the mount 104, may therefore comprise one or more attachment means (e.g. clips) arranged to allow one or more covers to be attached thereto.

In particular, in the embodiment being described the mount 104 comprises a pair of arms 106. Each arm 106 is connected to the headband 102 on a respective side of the headband 102 (and therefore of a user's head/face in use), near a front of the headband, and extends forward and downward therefrom. Each arm 106 comprises a holder 108 arranged to receive one side of a display device, such that the display device is engagingly received therebetween. Each holder 108 may therefore be referred to as a display device holder. Each holder 108 may be designed to be able to hold the display device by itself (so providing some redundancy and additional security), or each may provide some support such that the pair of holders 108 together can hold the device in place securely.

In the embodiment shown, each arm 106 is biased or sprung so as to urge the ends of the arms 106 comprising holders 108 towards each other, for example with a natural, unstressed, spacing being slightly smaller than the expected minimum width of a display device mounted therebetween. The arms 106 may therefore each exert an inward force on a display device, improving grip and/or accurately (horizontally) centring the display device with respect to the headset 100, and therefore with respect to a user's intended field of view in use. This flexibility may allow a variety of display devices of different widths to be received by the same mount 104, in at least substantially the same position. The biased arms 106 of the present embodiment may therefore be described as “live hinged”, with a flexible portion of the same material providing biasing between more rigid regions of the same material. A separate biasing member such as a spring may be used in some embodiments. The arms 106 may not be biased in other embodiments.

The arms 106 extend at an angle to the headband 102 and are at least substantially straight from where they leave the headband 102 to a position on the mount 104 arranged to receive a lower edge of a display device (e.g. a smartphone); the arms 106 may therefore each be described as following a straight trajectory from the headband 102 to the base of the respective holder 108.

In the embodiment shown, the arms 106 extend at an angle to the headband 102, and the holders 108 extend at an angle to the rest of the arms 106, such that a screen of a display device held by the arms is at least substantially vertical. In particular, an angle, a, between the headband 102 and a surface of the holder 108 arranged to receive lower edge of the display device may be selected accordingly, bearing in mind an intended angle, β, of the headband 102 with respect to the horizontal.

It will be appreciated that the surface of the holder 108 arranged to receive the lower edge of the display device remains in its intended vertical position (within relatively small bounds) even when the holders 108 are pushed apart to insert a wider display device therebetween—further, even if a taller display device extends further upwards out of the open top of the holders 108, the lower edge of the display device remains at the same level irrespective of device dimensions. In embodiments in which the device extends outwards beyond the holders 108, the lower edge of the display device likewise remains at the same level irrespective of device dimensions. The angle from lenses 200 (described below) to that lower edge therefore remains at least substantially constant for all headset-compatible display devices—the headset 100 may therefore be arranged to hold the display device such that at least a lower edge of the display device is in a predetermined position with respect to the headset 100, and in particular with respect to the lenses 200.

In the embodiment shown, the angle, β, of the headband 102 with respect to the horizontal is intended to be somewhere between 6° and 46°, and optionally around 26°, with the headband 102 being lower behind a user's head than near a user's face. A position in this range has generally been found to provide a comfortable fit for a variety of skull shapes—with the back of the strap 102 below the head “bump” at the back of the skull and the front higher up on the forehead where the skull begins to curve backwards; this may prevent the weight of the display device from pulling the headset 100 downwards in use.

The angle, a, between the headband 102 and the arm 106, and more specifically from the headband 102 to a surface of the holder 108 arranged to receive a lower edge of the display device, along the arm, may be selected to be in the range from 95° to 135°, and optionally around 115°, accordingly. A user may then be advised to adjust the headband 102 such that a screen of the display device is vertical to get an appropriate angle for the headband 102. The surface of the holder 108 arranged to receive the lower edge of the display device may be arranged to be horizontal in use.

In various embodiments, the mount 104 is moveably mounted on the headband 102, and optionally slidably mounted thereon. In the embodiment shown, the mount 104 comprises a pair of slider portions 104a which are parallel to the headband 102 and slid ably mounted on the headband 102. The slider portions 104a may be mounted in a ratchet-type arrangement to allow a user to slide the mount 104 through a set of discrete positions—e.g. forward and backward from a user perspective—to select an appropriate fit. Each arm 106 extends at an angle from a respective slider portion 104a. In alternative embodiments, the arms 106 may be mounted to the headband 102 in a fixed position.

In the embodiment shown, each holder 108 is substantially tubular in shape, with a closed lower end (or base) 108a to the tube, and a cut-away portion along the length of the tube providing a lateral opening. The lateral openings of the pair of holders 108 are aligned with each other, and facing each other (and may therefore be described as inwardly-directed), so that opposing edges of a display device may be respectively received in each. In the embodiment shown, the holders 108 are arranged to be at least substantially vertical when the user is standing straight, and the closed lower end of each tube may support a lower edge of the display device at/near a corner thereof.

In the embodiment shown, the forward region of the front surface of each holder 108 is cut away from the closed base 108a, and resiliently biased into its tubular shape. This may facilitate inserting an edge of a display device into the lateral opening, and the flexibility and biasing may allow display devices of a variety of thicknesses to be received within the same holder 108. In particular, the forward region of the front surface each holder 108 has a vertical lip 108b, angled so as to be curled away from the tubular shape of the holder 108 and arranged to facilitate inserting an edge of a device into the lateral opening.

In the embodiment shown, the holder 108 is only approximately tubular in shape, having a flattened side in the region arranged to be closest to a user's face, the flattened side being arranged to rest against a front/screen side of the display device in use, so keeping an at least approximately constant horizontal distance, X, between a plane of the screen and a plane of the mount 104 (in particular, a plane of lenses mounted on the mount in the embodiment shown). It will be appreciated that the arms 106 flexing outwards for a wider display device, or moving further inward for a narrower device, may move the device location away from the lens 200, or towards the lens 200, respectively, by a relatively small amount. The vertical lip 108b may be arranged to rest on, and grip, a rear surface of the display device, opposite the screen.

In other embodiments, different holder designs may be used from that shown, whilst still comprising a surface of the holder 108 arranged to receive the lower edge of the display device so that the device remains in its intended vertical position. In some such alternative embodiments, the holders 108 mounted on the arms 106 may be described as clips, gripping the display device from underneath (the device may be inserted from above). As compared to the holders 108 shown in the Figures, in which the arms 106 may be live-hinged so as to always contact the outer edges/sides, and particularly the outside bottom corners, of display devices of varying sizes, the holders 108 of other embodiments may be located a fixed distance apart, and the corners of a display device may extend beyond the holders 108, by an extent depending on display device size. More rigid, non-live-hinged, arms 106 with holders 108 clipping around the lower edge of the device may allow more secure and straightforward mounting in some embodiments, and the distance between the lenses 200 and the device screen may be more precisely fixed regardless of device size (it will be appreciated that, with live hinges, wider devices may be positioned slightly closer to the lenses 200 than narrower ones as the arms 106 flex, which may provide small variations in focus). In such embodiments, it will be appreciated that the holders 108 are still generally arranged to be at or near a side edge of the display device, to minimise or avoid occlusion of the display (and in particular of the relevant area of the display, as described below). All or part of the holders 108 may be transparent in some embodiments, which may further reduce occlusion. Whereas the holders 108 shown in the Figures provide inwardly-directed openings facing each other with a solid outer surface, other holders may therefore have upward-facing openings and no solid outer edge surface. It will be appreciated that any suitable grip design known in the art may be used, and that the scope of the invention is not limited by holder type.

The design and positioning of the lenses 200 may result in an almost-circular area of a screen of the device being visible in each eye. This area may have a fixed size and position regardless of the device dimensions. The grips/holders 108 are therefore designed to fall outside of that visible area (towards the sides/edges of the device), but may be located inwardly from the device edges without occluding that visible area.

In the embodiments described herein, the ends of the arms 106 are unconnected to each other when the display device is not between them. It will be appreciated that this open structure is a marked departure from prior art designs which generally have a box or goggles surrounding and covering a significant portion of the user's face. The headset 100 as described herein moves away from the idea of having an enclosed frame (with or without any “windows”), instead providing an entirely redesigned product which keeps as much peripheral vision open as possible. In the embodiment shown, the holders 108 are designed to receive a substantially cuboid display device which is much wider and taller than it is thick—as this is a standard shape for current smartphones and tablets. Differing holder designs may be used as appropriate in embodiments arranged to receive differently shaped display devices.

In the embodiment shown, the arms 106 are interconnected so as to form a single piece mount 104. In alternative embodiments, the arms 106 may be separate, and each individually mounted on the headband 102. The interconnection may improve rigidity and/or accuracy of screen positioning.

In the embodiment being described, the mount 104 further comprises a strut 105 extending between the arms 106 and connecting them together. The strut 105, which may be referred to as a cross piece, as it extends across a portion of the headset 100, extends at least substantially horizontally, and is arranged to be located above a user's eyes and adjacent a user's forehead in use, in much the same way as the upper part of the frame of a pair of glasses. The strut 105 may be arranged to rest on a user's forehead in some embodiments, and may help to support the display device/to secure a position of the headset 100 in some embodiments. The strut 105 may be arranged to be spaced forward from a user's forehead in other embodiments.

In the embodiment shown, each arm 106 has a width of around 1 cm and a thickness which varies with height, increasing from around 0.25 cm in an upper region 1002 to about 0.35 cm in a lower region 1004, as illustrated by the cross-sectional view 1000 shown in FIG. 10, taken along line A-A. The strut 105 of the embodiment being described is more rigid than the arm 106, with a thickness of around 0.5 cm of the same material.

It was determined through experimentation that, for the design and materials of the embodiment being described, a rectangular cross-section of the arms 106 led to the arms 106 splaying outwards when a display device was mounted thereon, resulting in the base 108a of the holder 108 being angled out away from the vertical in some cases, so not supporting the display device in the desired position. The cross-sectional profile 1000 shown in FIG. 10, with thickness decreasing with height, was found to reduce this splaying, so improving display device positioning. This more triangular, or trapezoidal, arm profile 1000 was found to increase flexibility along the top edge 1002 of the arm 106, especially at the connection point where the arms 106 meet the holders 108, allowing them to be more easily twisted/influenced by the display device's outer profile whilst remaining in contact with, and parallel to, the edges of the display device (e.g. a phone). By contrast, the tendency when the arms 106 were rectangular in profile was for the holders 108 to turn outward and not remain parallel or fully in safe contact with the display device edges or bottom surface. The decrease in arm thickness with height may be present in just a portion of the arm 106 near the holder 108, for example in some or all of the region of the arm 106 between the strut 105 and the holder 108 in the embodiment shown. In other embodiments, this variable-thickness profile 1000 may be present along the full length of each arm 106.

In embodiments in which the arms 106 are biased by a live hinge-type arrangement, the strut 105 may rigidify a portion of the mount/arms such that only the portion of each arm 106 between the strut 105 and the holder 108 bends in use, as a display device is inserted or removed.

In the embodiment shown, the strut 105 extends forwardly from each arm 106, and at an angle thereto so as to allow the strut 105 to be at least substantially horizontal, and then curves towards the other arm 106 (through an angle of around 90° in the embodiment shown), with a straight portion connecting the two curved corners. A different shape, for example a more angular shape, may be used in other embodiments.

In the embodiment being described, the strut 105 comprises one or more connectors 107 arranged to hold lenses 200 between the user's eyes and the display device, such that the user can view the display of the display device through the lenses. The lenses 200 are therefore mounted to the arms 106 via the cross-piece strut 105—as a result, in embodiments in which the mount 104 is moveably mounted on the headband 102 (e.g. slidably), the lenses 200 can move with the display device. This may help to maintain correct alignment between the lenses 200 and display device as compared to mounting the lenses 200 separately to the headband 102. As the mount 104, and therefore the arms 106, are adjustable with respect to the headband 102 in such embodiments, adjustment for different head shapes is facilitated—having the lenses 200 mounted on the arms 106 maintains a constant lens to device screen distance, the distance being kept at the appropriate constant value for correct focus (that distance is generally found to be more important to be fixed than the eye to lens distance).

In alternative embodiments, one or more connectors 107 for lenses 200 may be connected to the headband 102 directly/not via the same mount 104 as used to support a display device.

In the embodiment being described, the one or more connectors 107 are arranged to have the lenses 200 removably connected thereto, such that lenses 200 can be replaced, e.g. if damaged, or to accommodate a user's prescription or a visual choice. In alternative embodiments, the lenses 200 may be permanently connected to the headset 100, and/or may be integral with the connectors 107, for example being made of the same, optionally polymeric, material. In various embodiments, the one or more connectors 107 are also made of a transparent material. Generally, the transparent material may be colourless, however, in some embodiments, a coloured or tinted lens may be used.

The lenses 200 are connected to the headset 100 in such a way that there is no part of the connector or other frame along a lower edge of the lenses 200—the lenses 200 may therefore be described as being rimless or frameless along at least their lower edges.

In some embodiments, a lens 200 of a known kind may be used, such as those described in the Google Cardboard technical specifications (available here: https://arvr.google.com/intl/en_uk/cardboard/manufacturers/). However, an improved lens design found to reduce interference with a user's peripheral vision, as described below, is used in various embodiments.

In the embodiment being described, two lenses 200 made of optical grade PMMA (Poly(Methyl MethAcrylate)) are detachably connected to a connector 107.

In the embodiment shown, each lens 200 is connected to a separate portion 107a, 107b of the connector 107; these separate portions 107a, 107b are slidably mounted on a joining portion of the connector 107 such that a spacing between the lenses 200 can be adjusted. This may allow for adjustment for a specific user's inter-pupillary distance, and/or may provide improved fit across a variety of face shapes. This use of two separate, relatively-moveable, connection portions may alternatively be described as the headset 100 comprising a pair of connectors 107a, 107b.

In this embodiment each connector portion 107a, 107b is arranged to hold an inner edge of the respective lens 200 (i.e. an edge arranged to be nearest a user's nose in use). The connector portion 107a, 107b is arranged to grip only this inner edge of the lens 200 in some embodiments; in other embodiments, the connector portion 107a, 107b may be arranged to grip an upper edge of each lens 200 in addition (or instead), and/or the outer edge.

In the embodiment shown, each lens 200 has an optical portion 202, through which light is transmitted to a user, and a joining portion 204, arranged to facilitate connecting the lens 200 to the connector. In the embodiment shown, the joining portion 204 comprises two shaped protrusions, or tabs, arranged to be received and gripped within respective sockets in the corresponding portion of the connector 170. In the embodiment shown, each tab extends by a distance, T, of 3 to 4 mm, and optionally of around 3.95 mm, on the side of the lens arranged to be nearest a user's nose in use. The skilled person will appreciate that many different connector designs are possible and that this example is not intended to be limiting.

The lenses 200 may be arranged to reduce a user's view of one or more edges of a display device mounted on the headset 100, so restricting a user's view to a digital display of the display device and the user's peripheral vision with minimal interruption therebetween, providing a more seamless visual transition. The lenses 200 may be arranged such that peripheral vision is maintained as much as possible without the display device becoming visible outside/around the lens.

In the embodiment shown, each lens 200 is a double convex lens. Optical properties of the lenses may be selected in line with other lenses used in the field of AR and VR applications; for example, 34 mm diameter aspherical singlet lenses with an 80° field of View may be used as described for Google® Cardboard (I/O 2015 edition). Various effective diameters and other dimensions are visually indicated in FIG. 9, although it will be understood that these lens images are provided by way of example only, and that lens curvature may also be adjusted depending on the refractive index of the chosen lens material, the chosen eye-display device spacing (and/or lens-display device spacing, X, as marked in FIG. 5), and other factors known to one skilled in the art. The precise lens shape shown in FIG. 9 is therefore not intended to be limiting.

Unlike other lenses used in the field, however, the lenses 200 of the embodiment being described are “cut away” so as to have a flat, horizontal, lower edge, instead of the more traditional circular or oval shape. It will be appreciated that the term “cut-away” is used for illustrative purposes only and is not intended as a comment on manufacturing processes—the lens 200 may be moulded to the desired shape without any part thereof needing to be removed.

In the embodiment shown, each lens 200 has a maximum width (in the horizontal direction) of around 34 mm. The lens 200 may be substantially circular in front view, but with a cut-away portion providing a flat lower edge. In the embodiment shown, the flat lower edge has a length, L, of around 19 mm. The lens 200 may have a maximum height, H, of around 25-30 mm. These dimensions may vary in other embodiments.

In the embodiment shown, each lens 200 is a double convex lens, having a first convex surface 206 adjacent a user's eye and a second convex surface 208, optionally of a different curvature, on the opposing side. In the embodiment shown, the surface 206 facing the user's eye in use is less convex than the surface 208 facing away from the user's eye. The curvatures may vary in other embodiments. The edges of each lens 200 have a non-negligible width, which may facilitate mounting of the lenses 200. The curved surfaces therefore do not meet at a point in the embodiment shown, but rather have a flat lens edge therebetween. In the embodiment shown, the flat portion between the curved surfaces has a thickness of around 1.4 mm, and the lens 200 has a maximum total width of around 8.8 mm, including that flat portion. These dimensions may vary in other embodiments.

Each lens 200 is arranged such that its flat lower edge is arranged to fall on a plane extending between a user's expected pupil locations and a lower surface 108a of the mount 104 arranged to receive the display device—the lower surface 108a of the mount is generally at least substantially level with a lower edge of a screen of the display device in use. Each lens 200 is therefore arranged such that its flat lower edge falls on a plane extending between a user's expected pupil locations and a predetermined intended position of the lower edge of the display device/screen.

In the embodiment shown, the connectors 107 and mount 104 are arranged such that a spacing, X, between a (vertical) centre line of the lens 200 and an intended location of a screen of the display device (as defined by the arms 106 and holders 108) is in the range from 26 to 46 mm (inclusive), and optionally is equal to or around 36 mm.

In the embodiment shown, the upper edge of each lens 200 is also flattened, optionally for ease of fit with the connector 107—this may vary in other embodiments.

In some embodiments, lenses 200 designed and located as described herein may be used with headsets 100 which are arranged to significantly block a user's peripheral vision (e.g. for fully-enclosed headsets used for a completely virtual experience), but they may be of particular utility with headsets 100 arranged to provide good peripheral vision, disguising the rim of the display device and providing a more seamless transition. The cut away portion may provide maximum direct vision of the real world on the lower surface of the display, and a more apparently straight transition between the two views (real and virtual/augmented). For example, a user's view of a lower edge of a frame, surround, or cover of a display device, and/or of one or more controls of the display device may be obscured from view due to the design of the lens 200 and its position relative to the display device, so providing a more immersive experience. Even for display devices such as bezel-less or “edgeless” smartphones, where a screen extends the full width and/or height of the device, the lens 200 may still help to provide a smoother apparent transition, without such a noticeable boundary at the edge of the display device. In some implementations, detachable covers may be provided which clip (or otherwise fit) onto a headset 100 as described herein, so as to allow a user's peripheral vision to be blocked for an immersive VR experience. The same hardware 100 may therefore have increased utility by allowing unimpeded peripheral vision in AR scenarios and enclosed vision in VR scenarios.

Further, in the viewing devices of some embodiments, the lenses 200 with flat lower edges as described herein may be used with other supports in place of a headset 100; for example with supports arranged to hold a display device in a set position with respect to a pair of lenses 200, but to be held in position in front of a user's eyes by a user's hand, rather than being secured to a user's head. In such embodiments, the viewing device may be arranged to be held in place by a user holding the support, and/or holding the display device connected thereto (the support may be thought of as being mounted on the display device in the latter case). Similarly, in still further embodiments, a support may be provided at a fixed location—e.g. mounted on a wall—and a user may be encouraged to stand in a specific location to use the lenses 200 mounted on the support 200. In such embodiments, a display device may be permanently mounted to the support, instead of detachably connected so that a user may use a personal smartphone therewith, for example as part of a permanent installation. It will therefore be appreciated that lenses 200 designed as described herein, and arranged to be positioned as described herein with respect to a display device and a user's eyes, may be used with a wide variety of support designs, not limited to the example of a headset 100 described in detail herein. For example, the viewing device may be a minimal, handheld, fold-up viewer. It will be appreciated that a wide range of viewing devices may benefit from the neater transition between real and virtual content afforded by the flattened lens edges arranged as described herein.

A headset 100, or other viewing device, as described herein may be used for augmented reality applications, optionally providing virtual images which blend in with a user's peripheral vision so as to provide an immersive experience, with virtual elements blended with a user's real-world view. In such embodiments, the display device may be used to display a live video feed of the environment in front of the user, with overlaid (or otherwise incorporated) virtual images and/or text, so adding virtual content to the scene.

1. A headset for use as part of an Augmented Reality or Virtual Reality apparatus, the headset comprising:
a headband arranged to secure the headset to a user's head; and
a mount connected to the headband and comprising a pair of arms, each arm being connected to a respective side of the headband and comprising a holder arranged to detachably receive a display device in a position arranged to be in front of a user's eyes in use;
and wherein the headset is arranged not to block a user's peripheral vision.

2. The headset of claim 1, wherein the mount is arranged to receive a display device which comprises a smartphone.

3. The headset of claim 1, wherein the mount is at least substantially transparent.

4. The headset of claim 1, each holder is arranged to support a lower edge of the display device in use, such that the lower edge of the display device remains at the same level irrespective of device dimensions.

5. The headset of claim 4, wherein the arms are resiliently biased towards each other, such that display devices of varying widths may be accommodated therebetween and held in a central position.

6. The headset of claim 4, wherein the headband is arranged, in use, to encircle a user's head at an angle to the horizontal, such that the headband passes above a user's eyes, and around the back of a user's head at a level lower than the user's eyes, and wherein the arms are arranged such that a screen of the display device is at least substantially vertical in use.

7. The headset of claim 1, wherein the mount is arranged to be slideable along the headband.

8. The headset of claim 1, further comprising at least one connector connected to the headband and arranged to hold a lens between the user's eyes and the display device.

9. The headset of claim 8, wherein the at least one connector is arranged to have the lens removably connected thereto, such that the lens can be replaced.

10. (canceled)

11. The headset of claim 8, wherein the at least one connector is arranged such that there is no frame around a lower edge of a lens received thereon.

12. The headset of claim 1, further comprising a pair of lenses mounted thereon, the lenses being arranged to lie between the user's eyes and the display device in use.

13. The headset of claim 12, wherein the lenses are double convex lenses arranged to reduce a user's view of at least one edge of a display device mounted on the headset, so restricting a user's view to a digital display of the display device and the user's peripheral vision with minimal interruption therebetween.

14. The headset of claim 12, wherein a lower edge of each lens is flat, the flat edge being arranged to fall on a plane extending between a user's expected pupil location and a lower edge of the mount.

15. A headset for use as part of an Augmented Reality or Virtual Reality apparatus, the headset comprising:
a headband arranged to secure the headset to a user's head;
a mount connected to the headband and arranged to detachably receive a display device in front of a user's eyes; and
a pair of lenses connected to the headband and arranged to be located between the user's eyes and the display device in use,
and wherein the lenses are double convex lenses with a flat lower edge, the flat lower edge of each lens being arranged to fall on a plane extending between a user's expected pupil location and a lower edge of the mount.

16-19. (canceled)

20. A viewing device for use as part of an Augmented Reality or Virtual Reality apparatus, the viewing device comprising:
a support;
two lenses, each lens being a double convex lens with a flat lower edge, and being connected to the support; and
a display device holder, the display device holder being connected to the support and arranged to engagingly receive a display device such that a lower edge of the display device is held in a predetermined position relative to the lenses, and such that the display device is arranged to be viewed through the lenses in use.

21. The viewing device of claim 20, wherein the flat lower edge of each lens is arranged to lie on a plane extending between a user's expected pupil location and the predetermined position of the lower edge of the display device.

22. The viewing device of claim 20, wherein the display device holder has a lower surface arranged to support a lower edge of a display device in use, and wherein the flat lower edge of each lens is arranged to lie on a plane extending between a user's expected pupil location and the lower surface of the display device holder.

23. The viewing device of claim 20, wherein the support comprises a headset, the headset being arranged to hold the lenses in a set position in front of a user's eyes in use.

24. (canceled)

25. The viewing device of claim 20, wherein the support is arranged to clip to the display device, and the viewing device is arranged to be manually held in place in use by a user holding the display device.

26. The viewing device of claim 20, wherein the lenses are frameless along at least their flat lower edges.

27. (canceled)
